(19) United States
(12) Patent Application Publication
(10) Pub. No.: US 2025/0377258 A1
(43) Pub. Date: Dec. 11, 2025

(54) RAPID SEAL LEAK TEST USING HE OR CO2 GAS DETECTION

(71) Applicant: APPLIED Materials, Inc., Santa Clara, CA (US)

(72) Inventor: Paul R. McHugh, Kalispell, MT (US)

(73) Assignee: APPLIED Materials, Inc., Santa Clara, CA (US)

(21) Appl. No.: 18/734,312

(22) Filed: Jun. 5, 2024

(51) Int. Cl. G01M 3/32

(52) U.S. Cl. CPC G01M 3/3281

(57) ABSTRACT

A method of detecting a gas leak in a leak detection chamber, the method including lowering a pressure plate onto a first side of a seal assembly, sealing the pressure plate to the first side of the seal assembly, retaining a wafer in the seal assembly, filling the cavity with a detection gas through a valve in the pressure plate, and detecting whether the detection gas is present outside of the leak detection chamber. Further, a method of detecting a gas leak in a vacuum pre-wet (VPW) chamber, the method including backfilling a second volume with a detection gas on a first side of the seal assembly; and detecting whether the detection gas is present on a second side of the seal assembly.

### BACKGROUND

Electroplating equipment, such as elastomer seals, seal assemblies, wafers, and the like, need to be tested to ensure quality, and to check for imperfections in the equipment that may interfere with the electroplating process, such as non-uniformity of surfaces, air gaps or defects in equipment, and the like. One potential issue that electroplating equipment may experience is air gaps or seal defects that result in leaks between wafers and seals configured to retain and act as a gasket for the wafers. These issues can result in defects and/or deposition non-uniformities when the wafer is electroplated.

One way of detecting these air gaps defects (or leaks) is to test the electroplating equipment in a leak detection chamber. However, conventionally, retaining a wafer in a seal assembly before testing for leaks may result in pressure spikes that require longer time to normalize than a duration of the test window itself. Because of this it can be difficult to efficiently determine if leaks are present. In addition, conventional methods of setting system pressure and then measuring leak flow rates is inefficient for very small leaks. Again, detection of small leaks can take longer than the allotted time for the test.

Accordingly, devices, systems, and methods for detecting leaks associated with imperfections in electroplating equipment are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, disclosed herein is a method of detecting a gas leak in a leak detection chamber, the method including lowering a pressure plate onto a first side of a seal assembly, sealing the pressure plate to the first side of the seal assembly, retaining a wafer in the seal assembly, wherein the wafer contacts an elastomer seal, and wherein the elastomer seal, the pressure plate, and the wafer at least partially form a cavity, filling the cavity with a detection gas through a valve in the pressure plate, and detecting whether the detection gas is present outside of the leak detection chamber.

In some embodiments, the detection gas comprises helium. In some embodiments, the detection gas comprises carbon dioxide (CO₂). In some embodiments, the detection gas is detected with a gas sniffer. In some embodiments, the gas sniffer is disposed outside the leak detection chamber at an interface between the leak detection chamber and seal assembly.

In some embodiments, method further includes issuing a leak alert when the detection gas is detected. In some embodiments, the leak alert is reported to a software of the leak detection chamber. In some embodiments, the leak alert is a visual alert, an auditory alert, a haptic alert, or a combination thereof. In some embodiments, the leak alert corresponds to an elastomer seal imperfection, a wafer imperfection, or a combination thereof.

In some embodiments, the method further includes controlling a gauge pressure of the cavity to be between 0.1 and 0.3 pascals.

In yet another aspect, disclosed herein is a method of detecting a gas leak in a vacuum pre-wet (VPW) chamber, the method including retaining a wafer in a seal assembly, where the wafer contacts an elastomer seal, inserting the seal assembly into the VPW chamber, engaging a first side of the seal assembly with a seal of the VPW chamber, backfilling a first volume with a detection gas on the first side of the seal assembly, and detecting whether the detection gas is present on a second side of the seal assembly.

In some embodiments, the detection gas comprises helium. In some embodiments, the detection gas comprises carbon dioxide (CO₂). In some embodiments, detection gas is detected with a gas sniffer. In some embodiments, the gas sniffer is disposed inside the second volume.

In some embodiments, the method further includes issuing a leak alert when the detection gas is detected. In some embodiments, the leak alert is reported to a software of the leak detection chamber. In some embodiments, the leak alert is a visual alert, an auditory alert, a haptic alert, or a combination thereof. In some embodiments, the leak alert corresponds to an elastomer seal imperfection, a wafer imperfection, or a combination thereof.

In some embodiments, the method further includes determining whether the detection gas is at or above a gas threshold, and when the detection gas is at or above the gas threshold, issuing a leak alert.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A shows a conventional elastomer seal;

FIG. 1B shows a conventional seal assembly;

FIGS. 2A-2D are process diagrams of detecting a gas leak in a leak detection chamber 200, in accordance with the present technology

FIG. 3A is a vacuum pre-wet (VPW) chamber, in accordance with the present technology;

FIG. 3B is a closeup view of a seal assembly retained inside of a VPW chamber 700, in accordance with the present technology;

FIG. 4 is a method of detecting a gas leak, in accordance with the present technology;

FIG. 5 is another method of detecting a gas leak, in accordance with the present technology; and

FIG. 6 is yet another method of detecting a gas leak, in accordance with the present technology.

### DETAILED DESCRIPTION

Disclosed herein are devices, systems, and methods for detecting leaks in the wafer perimeter seal used in electroplating processes. In some embodiments, the seal leaks are detected using a leak detection chamber or a vacuum pre-wet (VPW) chamber. A seal assembly having an elastomer seal and retaining a wafer can be placed into either one of these chambers to determine if leaks are present. A detection gas, such as helium or carbon dioxide may be pumped either into a cavity formed between the seal assembly and a pressure plate of the leak detection chamber or a second volume between a second side of the seal assembly and the VPW chamber, respectively. In some embodiments, a gas detector May determine whether the detection gas in present in another area outside of the cavity or the second volume, indicating a leak. A leak may be undesirable, as it indicates a defect in the seal assembly, the wafer itself, or both. A lack of uniformity in the seal assembly or wafer can cause electroplating chemistry to contaminate the region behind the seal where the electrical contacts reside. These leaks can cause plating onto the electrical contacts, which can lead to local plating non-uniformities in electroplating, and plate up around the seal assembly, among other issues.

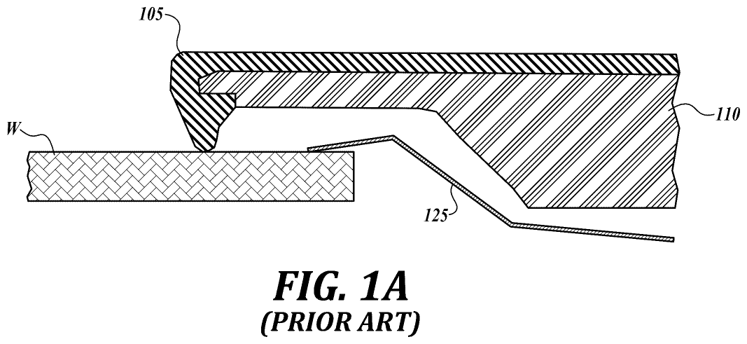

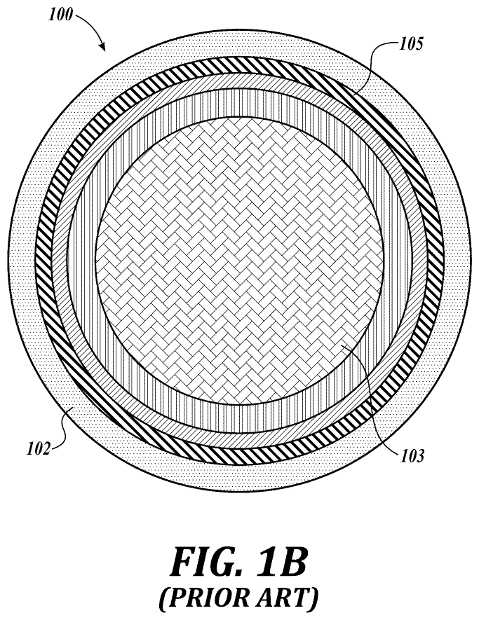

FIG. 1A shows a conventional elastomer seal 105. The elastomer seal 105 and the electrical contact 125 contact a wafer W when the wafer W is electroplated. A metal insert 110 is disposed about the elastomer seal 105 to provide additional structural integrity to the elastomer seal 110. Further, a metal contact 125 also contacts the wafer W during the electroplating process. In many embodiments, the metal contact 125 serves as an electrical electrode during the wafer processing (e.g., metal deposition).

In operation, the elastomer seal 105 operates as a gasket while the wafer W while is electroplated. The elastomer seal 105 may be a portion of a seal assembly, as shown in FIG. 1B.

FIG. 1B shows a conventional seal assembly 100. The seal assembly 100 is cylindrical. A wafer (such as wafer W shown in FIG. 1A) is retained in a wafer chamber 103. The elastomer seal 105 contacts the wafer to prevent it from moving and to prevent leakage of the working fluids (e.g., electroplating fluid) during the electroplating process. Sidewalls 102 surround the wafer and further retain the wafer during the electroplating process.

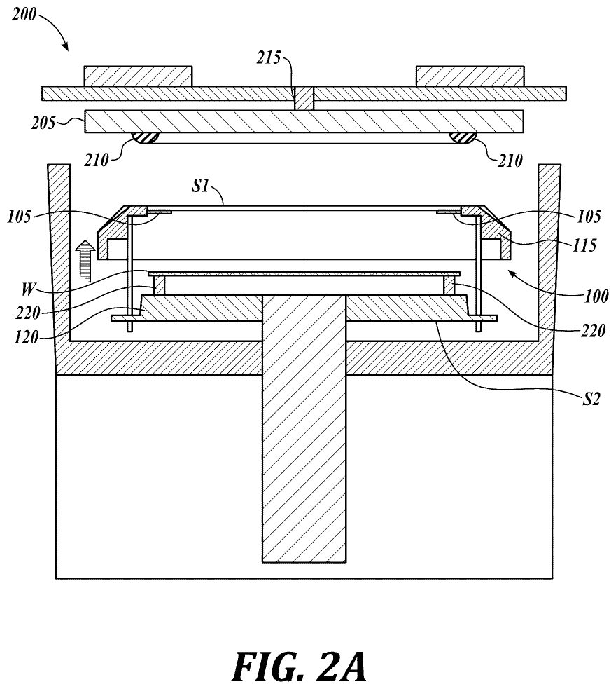

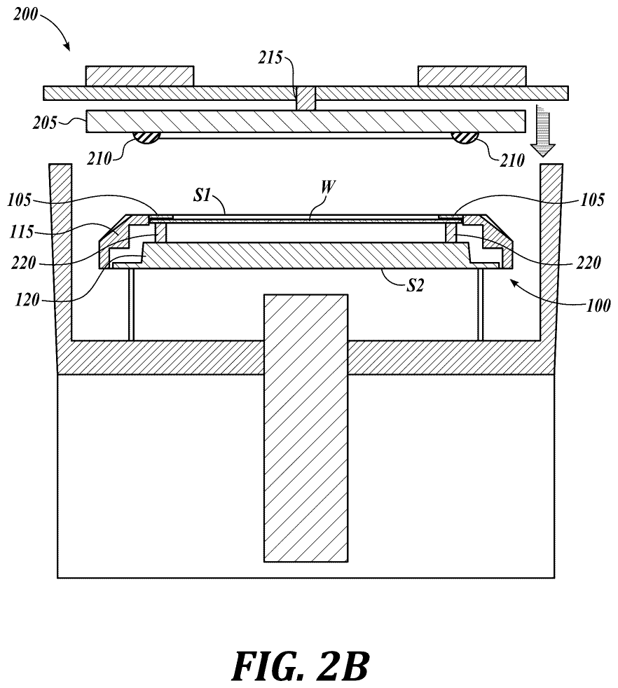

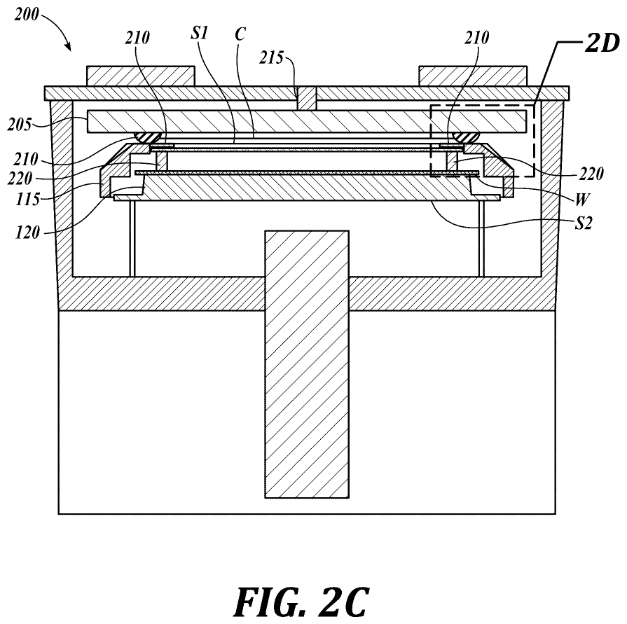

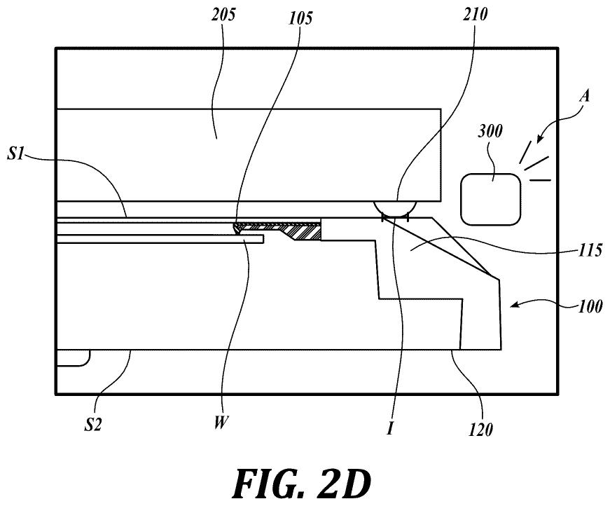

FIGS. 2A-2D are process diagrams of detecting a gas leak in a leak detection chamber 200, in accordance with the present technology.

FIG. 2A is a leak detection chamber 200, in accordance with the present technology. In some embodiments, the leak detection chamber 200 includes a pressure plate 205, one or more pressure plate seal 210, and a valve 215. In some embodiments, the leak detection chamber 200 is configured to retain a seal assembly 100 (such as the seal assembly 100 shown in FIG. 1B).

In some embodiments, the seal assembly 100 includes a top portion 115 including an elastomer seal 105 and a bottom portion 120. The seal assembly 100 may have a first side S1 and a second side S2, where the second side S2 is opposite the first side S1. The top portion 115 and the bottom portion 120 are configured to couple together to retain a wafer W. In some embodiments, the wafer W is placed on the upper surface of the bottom portion 120.

FIG. 2B shows the seal assembly 100 retaining the wafer W inside the leak detection chamber 200. The bottom portion 120 of the seal assembly 100 may be raised to couple with the top portion 115 to retain the wafer W into the seal assembly 100 and to allow the elastomer seal 105 to act as a gasket. In some embodiments, the top portion 115 and the second portion 120 couple with one or more magnets, connectors, snaps, or other couplers. When the top portion 115 and the second portion 120 couple, the second portion 120 forms the second side S2 of the seal assembly 100.

In operation, the seal assembly 100 is placed into the leak detection chamber 200. In some embodiments, the top portion 115 and the bottom portion 120 are coupled to retain the wafer W in the seal assembly 100. The pressure plate 205 is lowered onto the first side S1 of the seal assembly 100, as shown in more detail in FIGS. 2C and 2D.

FIG. 2C shows the seal assembly 100 retained in the leak detection chamber 200. In operation, as the pressure plate seal 210 meets the top portion 115 of the seal assembly 100, a cavity C is formed between the pressure plate 205 and the seal assembly 100. The pressure plate seal 110 forms an airtight seal with the top portion 115 of the seal assembly 100. Next, the cavity C may be filled with a detection gas through the valve 215 in the pressure plate. In some embodiments, the detection gas may be helium, carbon dioxide (CO2), or a combination thereof. In some embodiments, the cavity C may be pressurized by the detection gas. In some embodiments, a pressure of the cavity C may be between about 0.1 to about 0.3 psi.

The dashed box 2D is a portion of the leak detection chamber 200 and the seal assembly 100 shown in closer detail in FIG. 2D.

FIG. 2D is a closeup view of a seal assembly 100 retained inside of a leak detection chamber 200, in accordance with the present technology. In some embodiments, when the top portion 115 and the bottom portion 120 of the seal assembly 100 are coupled, the elastomer seal 105 touches the wafer W. An insert 110 maintains the shape of the elastomer seal 105. In some embodiments, a gas detector 300 determines whether the detection gas is present outside of the leak detection chamber 200.

In some embodiments, the gas detector 300 is a gas sniffer. In some embodiments, the gas detector 300 is disposed outside the leak detection chamber 200. In some embodiments, the gas detector 300 is located outside an interface I between the pressure plate seal 210 and the first side S1 of the seal assembly 100. A person of ordinary skill would know that the gas detector 300 should be located proximate to the interface I in order to sense a certain concentration of the gas that leaked outside of the cavity C.

In operation, if the gas detector 300 detects the detection gas outside of the interface between the pressure plate seal 210 and the first side S1 of the seal assembly 100, the gas detector 300 may issue a leak alert A. In some embodiments, the first side S1 is the side where the detection gas is introduced. Any leaking gas is detected by detector 300, which is outside the seal 210. In some embodiments, the leak alert A is a visual alert (such a steady or flashing light-emitting diode (LED)), an auditory alert (such as a chime, tone, or the like), a haptic alert (such as a vibration), or a combination thereof. In some embodiments, the gas detector 300 is configured to communicate with software of the leak detection chamber 200. In some embodiments, the alert A is reported to the software so that corrective action may be taken. For example, the wafer W may not proceed with processing if a leak is detected. In some embodiments, the leak alert A corresponds to an elastomer seal imperfection, a wafer imperfection, or a combination thereof. In some embodiments, the gas detector 300 is configured to compare an amount of detection gas present at the first side S1 of the seal assembly 100 to a gas threshold. If the amount of detection gas is above or at the gas threshold, the leak alert A may be issued. As explained herein, a leak may be undesirable, as it indicates a defect in the seal assembly, the wafer itself, or both.

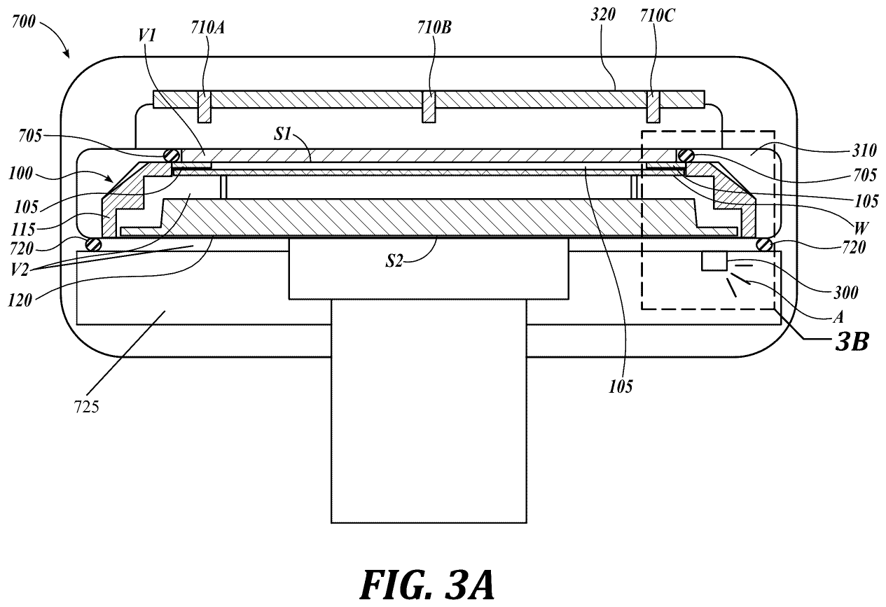

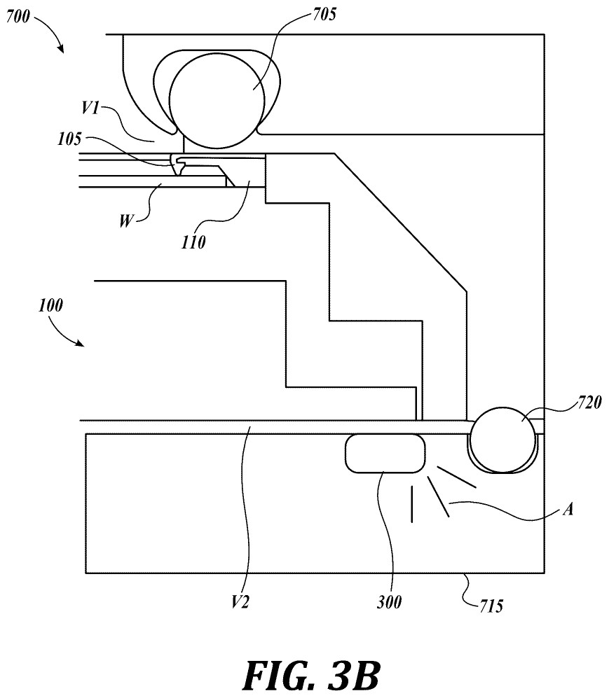

FIG. 3A is a vacuum pre-wet (VPW) chamber 700, in accordance with the present technology. In some embodiments, the VPW chamber includes a lid portion 703, one or more seals 705, one or more gas valves 710A, 710B, 710C, a lower seal 720, and a lower section 725. While three gas valves 710A, 710B, 710C are illustrated, one skilled in the art will recognize that any number of gas valves may be used, such as one valve (as shown in FIGS. 2A-2D). In some embodiments, the one or more seal 705 is configured to meet a first side S1 of a seal assembly 100 (such as seal assembly 100 in FIG. 1A). In some embodiments, the lower seal 720 is configured to meet a second side S2 of the seal assembly 100 and the lower section 725. In some embodiments, the lower seal 720 forms a second volume V2. The second volume V2 may be both the area formed by the lower seal 720 and the space on the backside of wafer W inside the seal assembly 100 (as shown in FIG. 3A).

In some embodiments, the seal assembly 100 includes a top portion 115 including an elastomer seal 105 and a bottom portion 120. The seal assembly 100 may have a first side S1 and a second side S2, opposite the first side S1. The top portion 115 and the bottom portion 120 are configured to couple together to retain a wafer W. In some embodiments, the wafer W is placed onto the bottom portion 120.

In some embodiments, the lid portion 703 and the one or more seals 705 form a first volume VI between the lid portion and the seal assembly 100. In some embodiments, a second volume V2 is located at the second side S2 of the seal assembly 100. In some embodiments, a gas detector 300 is located on or integrated inside of the lower section 725. In some embodiments, the gas detector 300 is configured to issue an alert A as described herein.

FIG. 3B is a closeup view of a seal assembly 100 retained inside of a VPW chamber 700, in accordance with the present technology. In operation, the wafer W is retained in the seal assembly 100. The wafer W may contact an elastomer seal 105 and a metal contact (such as metal contact 125 of FIG. 1A). The seal assembly 100 may then be inserted into the VPW chamber 700. The first side S1 of the seal assembly 100 may be engaged with one or more seals 705 of the VPW chamber 700. In some embodiments, an interface I between the first side S1 of the seal assembly 100 is airtight. In some embodiments, the first volume V1 may then be pumped down and backfilled with detection gas. In some embodiments, the detection gas includes helium, carbon dioxide (CO2), or a combination thereof. A gas leak may then be detected if the detection gas is present in the second volume V2 of the seal assembly 100.

In some embodiments, a gas detector 300 determines whether the detection gas is present outside of the VPW chamber 700.

In some embodiments, the gas detector 300 is a gas sniffer. In some embodiments, the gas detector 300 is disposed outside the leak detection chamber 200. In some embodiments, the gas detector 300 is located outside the interface I between the VP2 chamber seals 705 and the first side S1 of the seal assembly 100.

In operation, if the gas detector 300 detects the detection gas in the second volume V2, the gas detector 300 may issue a leak alert A. In some embodiments, the gas detector 300 is configured to communicate with software of the VPW chamber 700. In some embodiments, the alert A is reported to the software so that corrective action may be taken. For example, the wafer W may not proceed with processing if a leak is detected. In some embodiments, the leak alert A is a visual alert (such a steady or flashing light-emitting diode (LED)), an auditory alert (such as a chime, tone, or the like), a haptic alert (such as a vibration), or a combination thereof. In some embodiments, the leak alert A corresponds to an elastomer seal imperfection, a wafer imperfection, or a combination thereof. In some embodiments, the gas detector 300 is configured to compare an amount of detection gas present at the first side S1 of the seal assembly 100 to a gas threshold. If the amount of detection gas is above or at the gas threshold, the leak alert A may be issued.

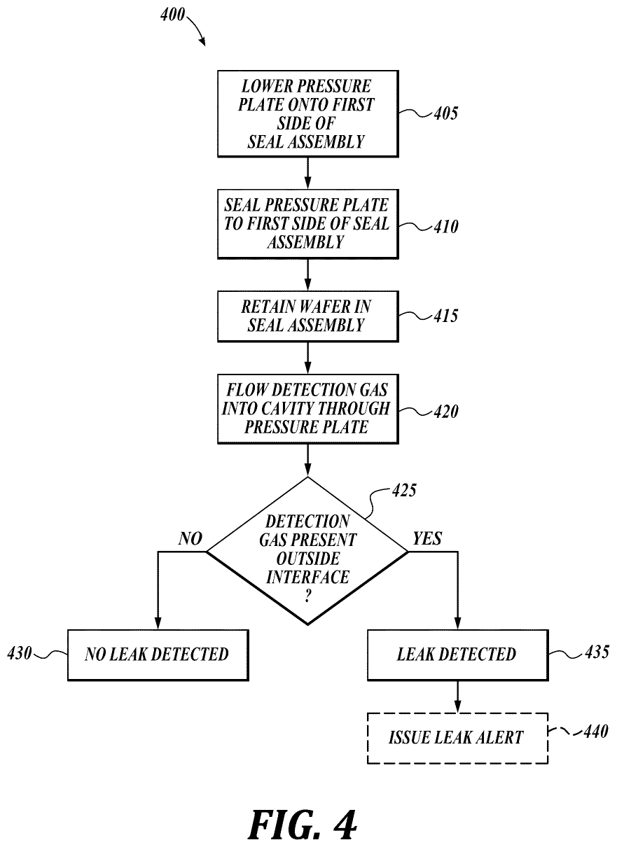

FIG. 4 is a method 400 of detecting a gas leak, in accordance with the present technology. In some embodiments, the method 400 is carried out with a leak detection chamber (such as leak detection chamber 200) having a pressure plate (such as pressure plate 205), one or more seals (such as seal 210), and a valve (such as valve 215). In some embodiments, the leak detection chamber retains a seal assembly (such as seal assembly 100) having a first side (such as first side S1) and a second side (such as second side S2) opposite the first side. In some embodiments, the seal assembly further includes an elastomer seal (such as elastomer seal 105) and a wafer (such as wafer W). The wafer may be held between a top portion (such as top portion 115) and a bottom portion (such as bottom portion 120) of the seal assembly.

In block 405, the pressure plate is lowered onto the first side of the seal assembly. In some embodiments, the first side of the seal assembly exposes the elastomer seal. In some embodiments, the first side of the seal assembly corresponds with the top portion of the seal assembly. In some embodiments, when the pressure plate is lowered, the one or more seals of the leak detection chamber meet the top portion of the seal assembly.

In block 410, the pressure plate is sealed to the first side of the seal assembly with the one or more seals. In some embodiments, pressure is exerted onto the pressure plate to form an airtight seal between the one or more seals of the leak detection chamber and the top portion of the seal assembly at an interface (such as interface I).

In block 415, the wafer is retained in the seal assembly. In some embodiments, this is achieved by raising the bottom portion of the seal assembly to the top portion of the seal assembly. In some embodiments, the top portion and the bottom portion of the seal assembly couple, such as with one or more magnets, connectors, snaps, or the like. In this manner, the wafer contacts the seal and one or more contacts (such as metal contacts 125) and is retained inside the seal assembly.

In block 420, detection gas is flowed into a cavity (such as cavity C) between the one or more seals of the leak detection chamber, and the first side of the seal assembly. In some embodiments, the detection gas is helium, CO₂, or a combination thereof. In some embodiments, the detection gas is flowed into the cavity to maintain a gauge pressure of between 0.1 and 0.3 pascals.

In decision block 425, it is determined whether detection gas is present outside of the interface. In some embodiments, this is achieved with a gas detector (such as gas detector 300). In some embodiments, the gas detector is a gas sniffer. If no detection gas is detected, the method 400 proceeds to block 430.

In block 430, no leak is detected. In some embodiments, the wafer and/or the elastomer seal are determined suitable for electroplating.

Returning to decision block 425, if the detection gas is detected, the method 400 proceeds to block 435.

In block 435, a leak is detected. In some embodiments, if the detected leak is below a gas threshold, the wafer and/or elastomer seal may be determined suitable for electroplating, even if gas is detected. In some embodiments, if a leak is detected at all, the wafer and/or elastomer seal are determined unsuitable for electroplating.

Optionally, in block 440, the gas detector may issue a leak alert (such as leak alert A). In some embodiments, the gas detector is configured to communicate with software of the leak detection chamber. In some embodiments, the alert is reported to the software so that corrective action may be taken. For example, the wafer may not proceed with processing if a leak is detected. In some embodiments, the leak alert is a visual alert (such a steady or flashing light-emitting diode (LED)), an auditory alert (such as a chime, tone, or the like), a haptic alert (such as a vibration), or a combination thereof. In some embodiments, the leak alert corresponds to an elastomer seal imperfection, a wafer imperfection, or a combination thereof.

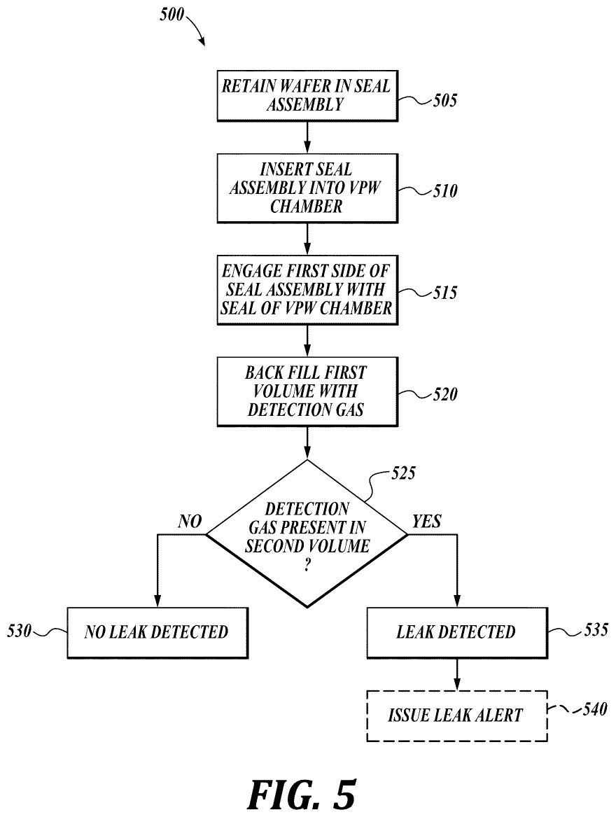

FIG. 5 is another method 500 of detecting a gas leak, in accordance with the present technology. In some embodiments, the method 500 is carried out with a vacuum pre-wet (VPW) chamber (such as VPW chamber 700) having a lid portion (such as lid portion 703), one or more VPW seals (such as one or more VPW seals 705), and one or more valves (such as one or more valves 710A, 710B, 710C). In some embodiments, the VPW chamber retains a seal assembly (such as seal assembly 100) having a first side (such as first side S1) and a second side (such as second side S2) opposite the first side. In some embodiments, the seal assembly further includes an elastomer seal (such as elastomer seal 105) and a wafer (such as wafer W). The wafer may be held between a top portion (such as top portion 115) and a bottom portion (such as bottom portion 120) of the seal assembly.

In block 505, the wafer is retained in the seal assembly. In some embodiments, this is achieved by raising the bottom portion of the seal assembly to the top portion of the seal assembly. In some embodiments, the top portion and the bottom portion of the seal assembly couple, such as with one or more magnets, connectors, snaps, or the like. In this manner, the wafer contacts the seal and one or more contacts (such as metal contacts 125) and is retained inside the seal assembly.

In block 510, the seal assembly is inserted into the VPW chamber. In some embodiments, the seal assembly may be placed into the VPW chamber and then covered with the lid portion of the VPW chamber.

In block 515, the first side of the seal assembly is engaged by the one or more VPW seals of the VPW chamber. In some embodiments, an interface (such as interface I) between the one or more seals and the first side of the seal assembly is airtight. In some embodiments, engaging the seal assembly with the one or more VPW seals forms a first volume (such as first volume V1) between the first side of the seal assembly and the one or more VPW seals. A second volume (such as second volume V2) may be formed between the wafer in the seal assembly and the bottom portion of the seal assembly. The elastomer seal with the wafer engaged may be loaded onto the lower section of the VPW. An advantage of using the VPW chamber is the pump-down and backfill capability. The first volume on the frontside of the wafer can be filled with detection gas (CO2, He, etc. . . . ). Leaks are determined by detecting this gas inside the second volume V2. If a leak is detected, then the VPW process can proceed. Otherwise, if a leak is detected, further processing of this wafer may be stopped.

In block 525, the second volume is back filled with a detection gas. In some embodiments, the detection gas is helium, CO₂, or a combination thereof.

In decision block 530, it is determined whether detection gas is present in the first volume. In some embodiments, this is achieved with a gas detector (such as gas detector 300). In some embodiments, the gas detector is a gas sniffer. If no detection gas is detected, the method 500 proceeds to block 535.

In block 535, no leak is detected. In some embodiments, the wafer and/or the elastomer seal are determined suitable for electroplating.

Returning to decision block 530, if the detection gas is detected, the method 500 proceeds to block 540.

In block 540, a leak is detected. In some embodiments, if the detected leak is below a gas threshold, the wafer and/or elastomer seal may be determined suitable for electroplating, even if gas is detected. In some embodiments, if a leak is detected at all, the wafer and/or elastomer seal are determined unsuitable for electroplating.

Optionally, in block 545, the gas detector may issue a leak alert (such as leak alert A). In some embodiments, the gas detector is configured to communicate with software of the VPW chamber. In some embodiments, the alert is reported to the software so that corrective action may be taken. For example, the wafer may not proceed with processing if a leak is detected. In some embodiments, the leak alert is a visual alert (such a steady or flashing light-emitting diode (LED)), an auditory alert (such as a chime, tone, or the like), a haptic alert (such as a vibration), or a combination thereof. In some embodiments, the leak alert corresponds to an elastomer seal imperfection, a wafer imperfection, or a combination thereof.

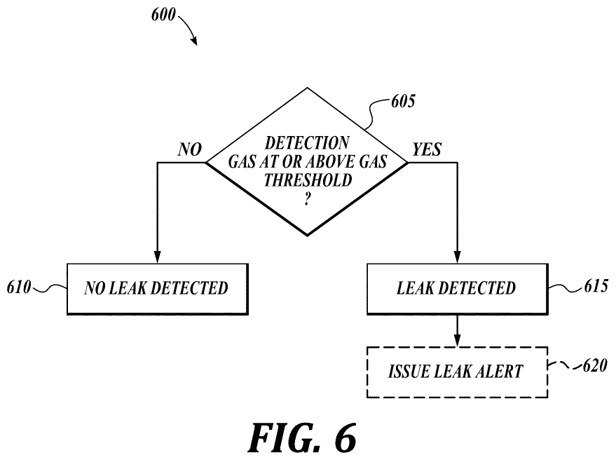

FIG. 6 is yet another method 600 of detecting a gas leak, in accordance with the present technology. In some embodiments, the method 600 is carried out with a leak detection chamber (such as leak detection chamber 200) having a pressure plate (such as pressure plate 205), one or more seals (such as seal 210), and a valve (such as valve 215). In some embodiments, the leak detection chamber retains a seal assembly (such as seal assembly 100) having a first side (such as first side S1) and a second side (such as second side S2) opposite the first side. In some embodiments, the seal assembly further includes an elastomer seal (such as elastomer seal 105) and a wafer (such as wafer W). The wafer may be held between a top portion (such as top portion 115) and a bottom portion (such as bottom portion 120) of the seal assembly.

In other embodiments, the method 600 is carried out with a vacuum pre-wet (VPW) chamber (such as VPW chamber 700) having a lid portion (such as lid portion 703), one or more VPW seals (such as one or more VPW seals 705), and one or more valves (such as one or more valves 710A, 710B, 710C). In some embodiments, the VPW chamber retains the seal assembly. In some embodiments, the method 600 occurs directly after method 400 or method 500.

In decision block 605, it is determined whether detection gas is detected at or above a gas threshold. In some embodiments, the gas threshold corresponds to an acceptable level of imperfection in the wafer or the elastomer seal. In some embodiments, when the detection gas is not at or above the gas threshold, the method proceeds to block 610. In some embodiments, a gas detector (such as gad detector 300) is configured to compare an amount of detection gas present to the gas threshold.

In block 610, no gas leak is detected.

Returning to decision block 605, if the amount of detection gas is above or at the gas threshold, the method 600 proceeds to block 615.

In block 615, a leak is detected. In some embodiments, if a leak is detected at all, the wafer and/or elastomer seal are determined unsuitable for electroplating.

Optionally, in block 620, the gas detector may issue a leak alert (such as leak alert A). In some embodiments, the gas detector is configured to communicate with software of the leak detection chamber or VPW chamber. In some embodiments, the alert is reported to the software so that corrective action may be taken. For example, the wafer may not proceed with processing if a leak is detected. In some embodiments, the leak alert is a visual alert (such a steady or flashing light-emitting diode (LED)), an auditory alert (such as a chime, tone, or the like), a haptic alert (such as a vibration), or a combination thereof. In some embodiments, the leak alert corresponds to an elastomer seal imperfection, a wafer imperfection, or a combination thereof.

It should be understood that all methods 400, 500, and 600 should be interpreted as merely representative. In some embodiments, process blocks of all methods 400, 500, and 600 may be performed simultaneously, sequentially, in a different order, or even omitted, without departing from the scope of this disclosure.

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

We claim:

1. A method of detecting a gas leak in a leak detection chamber, the method comprising:
lowering a pressure plate onto a first side of a seal assembly;
sealing the pressure plate to the first side of the seal assembly;
retaining a wafer in the seal assembly, wherein the wafer contacts an elastomer seal, and wherein the elastomer seal, the pressure plate, and the wafer at least partially form a cavity;
filling the cavity with a detection gas through a valve in the pressure plate; and
detecting whether the detection gas is present outside of the leak detection chamber.

2. The method of claim 1, wherein the detection gas comprises helium.

3. The method of claim 1, wherein the detection gas comprises carbon dioxide (CO₂).

4. The method of claim 1, wherein the detection gas is detected with a gas sniffer.

5. The method of claim 4, wherein the gas sniffer is disposed outside the leak detection chamber at an interface between the leak detection chamber and seal assembly.

6. The method of claim 1, wherein the method further comprises:
issuing a leak alert when the detection gas is detected.

7. The method of claim 6, wherein the leak alert is reported to a software of the leak detection chamber.

8. The method of claim 6, wherein the leak alert is a visual alert, an auditory alert, a haptic alert, or a combination thereof.

9. The method of claim 6, wherein the leak alert corresponds to an elastomer seal imperfection, a wafer imperfection, or a combination thereof.

10. The method of claim 1, wherein the method further comprises:
controlling a gauge pressure of the cavity to be between 0.1 and 0.3 pascals.

11. A method of detecting a gas leak in a vacuum pre-wet (VPW) chamber, the method comprising:
retaining a wafer in a seal assembly, wherein the wafer contacts an elastomer seal;
inserting the seal assembly into the VPW chamber;
engaging a first side of the seal assembly with a seal of the VPW chamber;
backfilling a first volume with a detection gas on the first side of the seal assembly,; and
detecting whether the detection gas is present in a second volume at a second side of the seal assembly, opposite the first side.

12. The method of claim 11, wherein the detection gas comprises helium.

13. The method of claim 11, wherein the detection gas comprises carbon dioxide (CO₂).

14. The method of claim 11, wherein the detection gas is detected with a gas sniffer.

15. The method of claim 14, wherein the gas sniffer is disposed inside the second volume.

16. The method of claim 11, wherein the method further comprises:
issuing a leak alert when the detection gas is detected.

17. The method of claim 16, wherein the leak alert is a visual alert, an auditory alert, a haptic alert, or a combination thereof.

18. The method of claim 16, wherein the leak alert is reported to a software of the leak detection chamber.

19. The method of claim 16, wherein the leak alert corresponds to an elastomer seal imperfection, a wafer imperfection, or a combination thereof.

20. The method of claim 11, wherein the method further comprises:
determining whether the detection gas is at or above a gas threshold; and
when the detection gas is at or above the gas threshold, issuing a leak alert.
